(19) United States
(12) Patent Application Publication
(10) Pub. No.: US 2025/0153487 A1
(43) Pub. Date: May 15, 2025

(54) LIQUID DROPLET JETTING APPARATUS AND MANUFACTURING METHOD OF PRINTED ARTICLE

(71) Applicant: FUJIFILM Corporation, Tokyo (JP)

(72) Inventors: Tadashi KYOSO, Kanagawa (JP); Tsutomu KUSAKARI, Kanagawa (JP); Satoshi WAKAMATSU, Kanagawa (JP)

(73) Assignee: FUJIFILM Corporation, Tokyo (JP)

(21) Appl. No.: 19/021,158

(22) Filed: Jan. 15, 2025

Related U.S. Application Data
(63) Continuation of application No. PCT/JP2023/022883, filed on Jun. 21, 2023.

(30) Foreign Application Priority Data
Aug. 9, 2022 (JP) 2022-126957

(51) Int. Cl. B41J 2/18; B41J 2/045; B41J 2/14; B41J 2/175; B41J 2/195; B41J 29/377

(52) U.S. Cl. CPC B41J 2/18; B41J 2/04581; B41J 2/14201; B41J 2/17566; B41J 2/17596; B41J 2/195; B41J 29/377

(57) ABSTRACT

Provided are a liquid droplet jetting apparatus and a manufacturing method of a printed article that maintain a good jetting state regardless of an ink to be used. A liquid droplet jetting apparatus includes: a liquid droplet jetting head that jets a liquid; a relative movement mechanism that moves a substrate and the liquid droplet jetting head relative to each other; and a control device that moves the substrate and the liquid droplet jetting head relative to each other and causes the liquid droplet jetting head to jet the liquid, to print an image on the substrate, in which a space between the liquid droplet jetting head and the substrate is a vacuum, the liquid droplet jetting head includes a circulation flow channel for circulating the liquid, and the control device circulates the liquid at least during printing.

### CROSS-REFERENCE TO RELATED APPLICATIONS

The present application is a Continuation of PCT International Application No. PCT/JP2023/022883 filed on Jun. 21, 2023 claiming priority under 35 U.S.C § 119 (a) to Japanese Patent Application No. 2022-126957 filed on Aug. 9, 2022. Each of the above applications is hereby expressly incorporated by reference, in its entirety, into the present application.

### BACKGROUND OF THE INVENTION

### 1. Field of the Invention

The present invention relates to a liquid droplet jetting apparatus and a manufacturing method of a printed article, and particularly relates to a technique of stabilizing a jetting state.

### 2. Description of the Related Art

In order to expand an application range of an ink jet technique, there is an issue in that it is desired to land liquid droplets onto a substrate without being strongly affected by air resistance even in a case in which a distance between an ink jet head and the substrate is wide.

In order to solve the above-described issue, JP5738513B discloses a printing system that performs printing via an ink jet method, the printing system comprising: an ink jet head having a nozzle that jets liquid droplets of a curable ink that is cured in accordance with energy received from an outside to a medium, an ultraviolet irradiation unit as a curing energy generation unit that generates energy for curing the ink landed onto the medium, a pressure reduction chamber that at least houses the ink jet head and the medium, a pump as a pressure reduction unit that reduces the atmosphere in the pressure reduction chamber to a pressure lower than an atmospheric pressure, and a water cooling device as a cooling unit that cools the ultraviolet irradiation unit via a refrigerant having a specific heat higher than that of the pressure-reduced air in the pressure reduction chamber.

### SUMMARY OF THE INVENTION

However, the printing system disclosed in JP5738513B has a problem in that the ink that can be used is limited. For example, there is a problem in that a solvent component in the ink is evaporated depending on a type of the ink, and the jetting state is deteriorated.

The present invention has been made in view of such circumstances, and an object of the present invention is to provide a liquid droplet jetting apparatus and a manufacturing method of a printed article that maintain a good jetting state even in a reduced pressure environment.

In order to achieve the above-described object, a first aspect of the present disclosure provides a liquid droplet jetting apparatus comprising: a liquid droplet jetting head that jets a liquid; a relative movement mechanism that moves a substrate and the liquid droplet jetting head relative to each other; and a control device that moves the substrate and the liquid droplet jetting head relative to each other and causes the liquid droplet jetting head to jet the liquid, to print an image on the substrate, in which a space between the liquid droplet jetting head and the substrate is a vacuum, the liquid droplet jetting head includes a circulation flow channel inside the liquid droplet jetting head, and the control device circulates the liquid through the circulation flow channel at least during printing. According to the present aspect, a good jetting state can be maintained.

A second aspect of the present disclosure provides the liquid droplet jetting apparatus according to the first aspect, in which it is preferable that the liquid droplet jetting head includes a jetting element including a nozzle, a pressure chamber, and a jetting energy generation element, and the circulation flow channel includes a supply flow channel for supplying the liquid to the jetting element and a recovery flow channel for recovering the liquid from the jetting element.

A third aspect of the present disclosure provides the liquid droplet jetting apparatus according to the first or second aspect, in which it is preferable that the liquid droplet jetting apparatus further comprises: a first liquid tank and a second liquid tank that store the liquid, and the control device supplies the liquid from the first liquid tank to the liquid droplet jetting head by using a head difference, and recovers the liquid from the liquid droplet jetting head to the second liquid tank by using the head difference.

A fourth aspect of the present disclosure provides the liquid droplet jetting apparatus according to the third aspect, in which it is preferable that the liquid droplet jetting apparatus further comprises: a chamber that internally houses the liquid droplet jetting head, the relative movement mechanism, the first liquid tank, and the second liquid tank; and an exhaust mechanism that creates a vacuum inside the chamber, and a reference of the head difference is a pressure inside the chamber.

A fifth aspect of the present disclosure provides the liquid droplet jetting apparatus according to the fourth aspect, in which it is preferable that the liquid droplet jetting apparatus further comprises: a liquid feed mechanism that supplies the liquid from the second liquid tank to the first liquid tank, and the liquid feed mechanism is disposed outside the chamber.

A sixth aspect of the present disclosure provides the liquid droplet jetting apparatus according to any one of the first to fifth aspects, in which it is preferable that the control device sets a circulation amount of the liquid during the printing to be greater than a circulation amount of the liquid during non-printing.

A seventh aspect of the present disclosure provides the liquid droplet jetting apparatus according to any one of the first to sixth aspects, in which it is preferable that the control device stops the circulation of the liquid during non-printing.

An eighth aspect of the present disclosure provides the liquid droplet jetting apparatus according to any one of the first to seventh aspects, in which it is preferable that the control device applies vibration to a non-jetting nozzle during the printing to an extent that the liquid droplet is not jetted.

A ninth aspect of the present disclosure provides the liquid droplet jetting apparatus according to any one of the first to eighth aspects, in which it is preferable that the liquid contains a solvent, the liquid droplet jetting apparatus further comprises a concentration measurement device that measures a concentration of the circulated liquid, and the control device adds an amount of the solvent that compensates for evaporation of the solvent to the liquid.

A tenth aspect of the present disclosure provides the liquid droplet jetting apparatus according to the fourth aspect, in which it is preferable that the liquid contains a solvent, and the solvent is disposed inside the chamber in an open state.

An eleventh aspect of the present disclosure provides the liquid droplet jetting apparatus according to the fourth or tenth aspect, in which it is preferable that the liquid droplet jetting apparatus further comprises: a circuit element for driving the liquid droplet jetting head, in which the circuit element is disposed outside the chamber.

A twelfth aspect of the present disclosure provides the liquid droplet jetting apparatus according to any one of the first to eleventh aspects, in which it is preferable that the vacuum is 0.5 atmospheres to 0.01 atmospheres.

A thirteenth aspect of the present disclosure provides the liquid droplet jetting apparatus according to any one of the first to twelfth aspects, in which it is preferable that the liquid is an aqueous ink containing water as a solvent.

In order to achieve the above-described object, a fourteenth aspect of the present disclosure provides a manufacturing method of a printed article, the manufacturing method comprising: creating a vacuum between a liquid droplet jetting head and a substrate, moving the substrate and the liquid droplet jetting head relative to each other, and causing the liquid droplet jetting head to jet a liquid, to print an image on the substrate; and circulating the liquid through a circulation flow channel of the liquid droplet jetting head at least during printing. According to the present aspect, a good jetting state can be maintained.

According to the aspects of the present invention, a good jetting state can be maintained even in a reduced pressure environment.

### BRIEF DESCRIPTION OF THE DRAWINGS

FIG. 1 is a side view showing an overview of a printing apparatus.

FIG. 2 is a plan view showing the overview of the printing apparatus.

FIG. 3 is a perspective view of a liquid droplet jetting head.

FIG. 4 is a plan perspective view showing a structure example of a silicon die.

FIG. 5 is a cross-sectional view taken along line 5-5 of FIG. 4.

FIG. 6 is a cross-sectional view taken along line 5-5 of FIG. 4 according to a modification example.

FIG. 7 is a schematic diagram showing a configuration example of a vacuum environment and ink circulation of the printing apparatus.

FIG. 8 is a schematic diagram showing a configuration example of a printing apparatus according to a second embodiment.

FIG. 9 is a schematic diagram showing a configuration example of a printing apparatus according to a third embodiment.

FIG. 10 is a schematic diagram showing a configuration example of a printing apparatus according to a fourth embodiment.

FIG. 11 is a schematic diagram showing a configuration example of a printing apparatus according to a fifth embodiment.

FIG. 12 is a schematic diagram showing a configuration example of a printing apparatus according to a sixth embodiment.

FIG. 13 is a block diagram showing an electric configuration of the printing apparatus.

### DESCRIPTION OF THE PREFERRED EMBODIMENTS

Hereinafter, a detailed description of preferred embodiments of the present invention will be made with reference to the accompanying drawings. In the description of the respective embodiments, illustration and description of parts common to the other embodiments will be omitted as appropriate.

### Overview of Printing Apparatus: First Embodiment

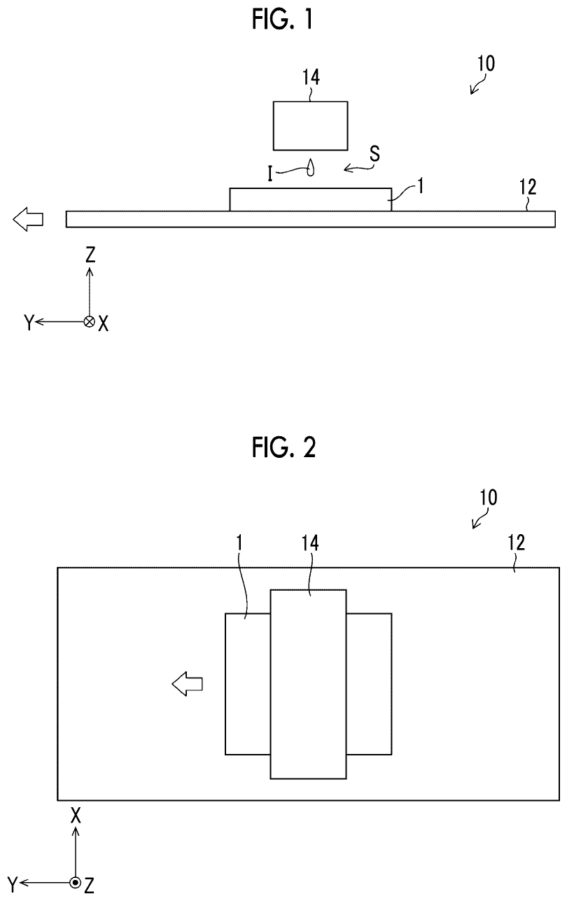

FIG. 1 is a side view showing an overview of a printing apparatus 10, and FIG. 2 is a plan view showing the overview of the printing apparatus 10. The printing apparatus 10 is a liquid droplet jetting apparatus that prints an image on a substrate 1.

The printing apparatus 10 comprises a transport device 12 and a liquid droplet jetting head 14. The transport device 12 is a relative movement mechanism that moves the substrate 1 and the liquid droplet jetting head 14 relative to each other by transporting the substrate 1 in a Y direction that is a horizontal direction. The liquid droplet jetting head 14 is an ink jet head that jets liquid droplets I of an aqueous ink (an example of a “liquid”) containing water as a solvent by using an ink jet method.

The printing apparatus 10 jets the liquid droplets I of the ink from the liquid droplet jetting head 14 onto a recording surface of the substrate 1 transported in the Y direction by the transport device 12, to form an image. The substrate 1 is, for example, a print substrate, and the ink is, for example, a conductive ink containing a conductive material. The printing apparatus 10 may comprise a head carriage that moves the liquid droplet jetting head 14 in an X direction.

In the printing apparatus 10, at least a space S between the liquid droplet jetting head 14 and the substrate 1 is a low vacuum in which a pressure is relatively lower than an atmospheric pressure (negative pressure). The atmospheric pressure is a pressure of the atmosphere of the printing apparatus 10, and may be 1 atmosphere. In addition, the negative pressure means about 0.5 atmospheres to 0.01 atmospheres at normal temperature, but the present invention is not limited to this. The negative pressure is a value measured by a vacuum gauge (for example, EA106B manufactured by ESCO Co., Ltd.).

In a case in which the space S is set to a low vacuum, the air resistance to the liquid droplets I can be reduced. Accordingly, even in a case in which a distance between the liquid droplet jetting head 14 and the substrate 1 is relatively large, such as 5 mm to 30 mm, the printing apparatus 10 can maintain a good jetting state and accurately land the liquid droplets I on the substrate 1. In a general printing apparatus, a distance between a liquid droplet jetting head and a substrate for accurate landing is about 0.5 mm to 2 mm.

### [Configuration of Liquid Droplet Jetting Head]

In a case in which the space S is set to a low vacuum, there is a concern that the jetting may be deteriorated due to the evaporation of the solvent of the ink. In the present embodiment, even in a case in which the solvent is evaporated from the ink, in order to stabilize the jetting state, a liquid droplet jetting head in which the ink circulates to the periphery of the nozzle is used.

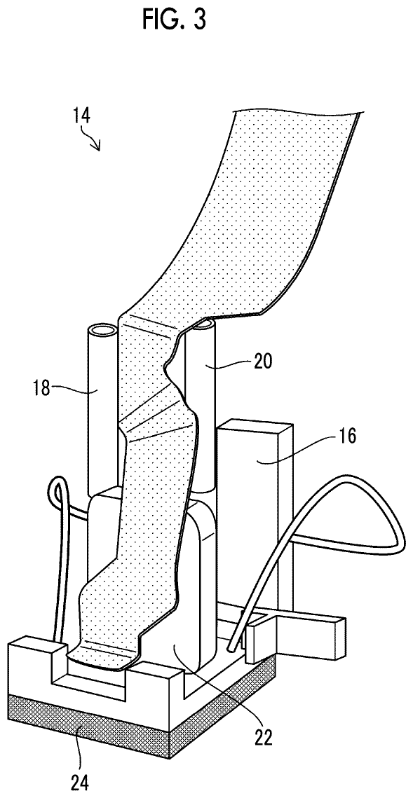

FIG. 3 is a perspective view of the liquid droplet jetting head 14. The liquid droplet jetting head 14 comprises an L-shaped bracket 16, a silicon die 24, an ink supply channel 18, an ink recovery channel 20, and a filter housing 22.

The L-shaped bracket 16 is a member for fixing the liquid droplet jetting head 14 to a head support member (not shown).

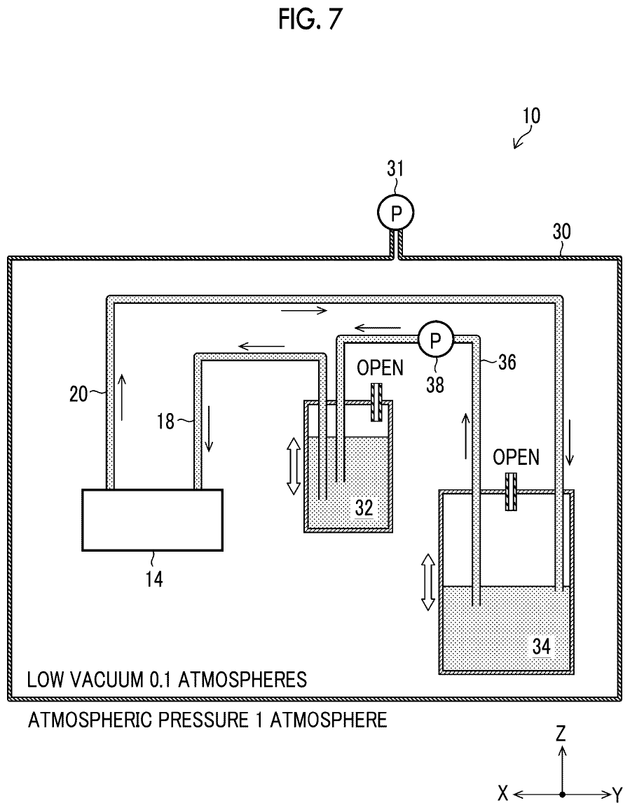

The ink supply channel 18 is connected to an upper ink tank 32 (see FIG. 7). The ink supply channel 18 supplies the ink from the upper ink tank 32 to the liquid droplet jetting head 14. The ink recovery channel 20 is connected to a lower ink tank 34 (see FIG. 7). The ink recovery channel 20 recovers the ink supplied to the liquid droplet jetting head 14 to the lower ink tank 34.

The filter housing 22 houses a filter for removing foreign substances and the like contained in the ink inside the liquid droplet jetting head 14.

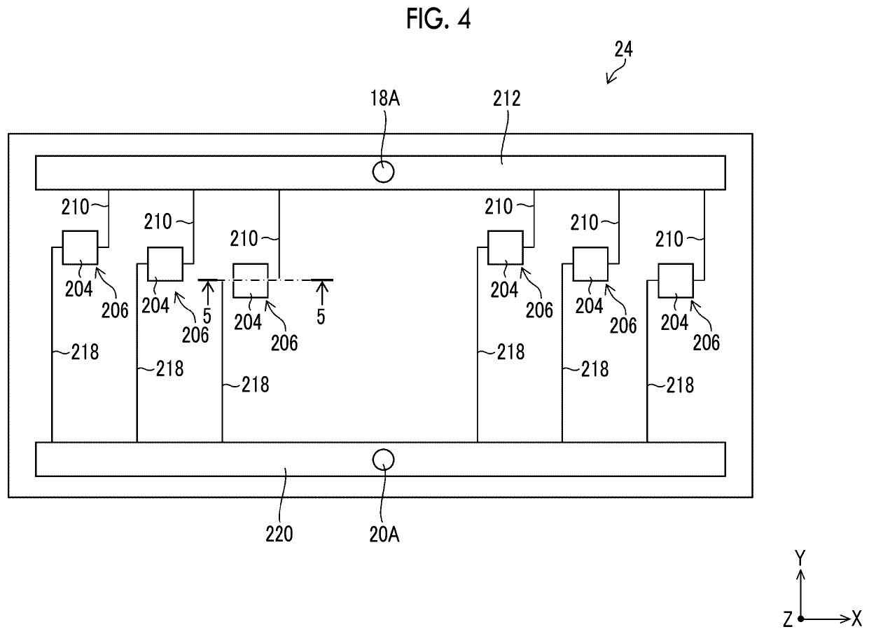

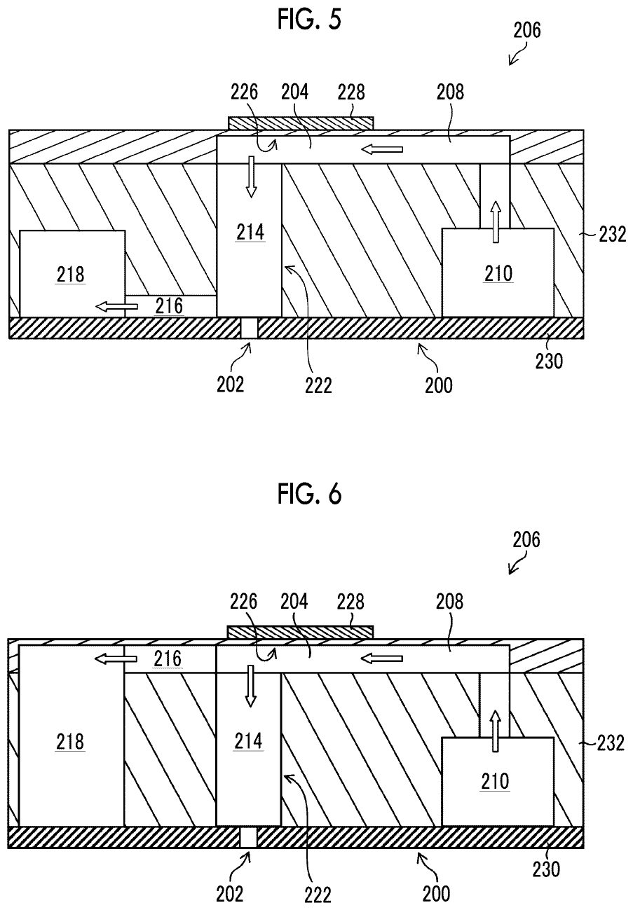

The silicon die 24 comprises a nozzle surface 200 (see FIG. 5) facing the substrate 1 transported by the transport device 12. FIG. 4 is a plan perspective view showing a structure example of the silicon die 24, and FIG. 5 is a cross-sectional view taken along line 5-5 of FIG. 4.

The silicon die 24 includes a nozzle plate 230 in which a nozzle 202, which is an outlet for ink droplets, is formed, and a flow channel plate 232 in which a flow channel for the ink is formed. The nozzle plate 230 and the flow channel plate 232 are laminated and joined. The flow channel plate 232 has a structure in which one or a plurality of substrates are laminated. The nozzle plate 230 and the flow channel plate 232 can be processed into a required shape through a semiconductor manufacturing process with silicon as a material.

The silicon die 24 comprises a plurality of nozzles 202 on the nozzle surface 200 that is a bottom surface. Further, each of a plurality of ink chamber units 206, which consists of a pressure chamber 204 or the like provided to correspond to each nozzle 202, is two-dimensionally disposed in a regular arrangement pattern. This achieves a substantially high density of the nozzle intervals projected to be arranged along the X direction.

The pressure chamber 204 communicates with a supply tributary 210 via a supply stop 208, and each supply tributary 210 communicates with a common flow channel 212. Further, a descender 214 that communicates with each pressure chamber 204 communicates with a circulation common flow channel 220 via an ink circulation channel 216 and a recovery tributary 218. An ink supply port 18A and an ink discharge port 20A are provided in the silicon die 24. The ink supply channel 18 (see FIG. 3) is connected to the ink supply port 18A. The ink recovery channel 20 (see FIG. 3) is connected to the ink discharge port 20A.

As described above, the ink supply port 18A and the ink discharge port 20A of the silicon die 24 are configured to communicate with each other via the common flow channel 212, the supply tributary 210, the supply stop 208, the pressure chamber 204, the descender 214, the ink circulation channel 216, the recovery tributary 218, and the circulation common flow channel 220.

Accordingly, the ink supplied from the ink supply channel 18 to the ink supply port 18A flows through the common flow channel 212, the supply tributary 210, the supply stop 208, the pressure chamber 204, and the descender 214, a part of the ink is jetted from each nozzle 202, and the remaining ink is discharged from the ink discharge port 20A to the ink recovery channel 20 via the ink circulation channel 216, the recovery tributary 218, and the circulation common flow channel 220.

In addition, a piezo actuator 228 comprising an individual electrode (not shown) is joined to a vibration plate 226 constituting a top surface of the pressure chamber 204 and serving as a common electrode. In a case in which a predetermined voltage is applied to the individual electrode, the piezo actuator 228 is deformed in a direction in which the pressure chamber 204 is contracted. As a result, the ink is jetted from the nozzle 202. Then, the piezo actuator 228 is deformed in a direction in which the pressure chamber 204 is expanded. As a result, a new ink is supplied from the common flow channel 212 to the pressure chamber 204 through the supply tributary 210 and the supply stop 208.

Here, the piezo actuator 228 is applied as a jetting energy generation element of the ink jetted from the nozzle 202, but a thermal method can also be applied in which the pressure chamber 204 comprises a heater and the ink is jetted by using a pressure of film boiling caused by heating the heater.

As described above, the liquid droplet jetting head 14 includes a jetting element 222 including the nozzle 202, the pressure chamber 204, and the piezo actuator 228. The liquid droplet jetting head 14 includes the supply tributary 210 (an example of a “supply flow channel”) that supplies the ink to the jetting element 222, and the recovery tributary 218 (an example of a “recovery flow channel”) that recovers the ink from the jetting element 222. The supply tributary 210 and the recovery tributary 218 constitute a “circulation flow channel”.

It is preferable that the ink circulation channel 216 is provided in the vicinity of the nozzle 202. Herein, the ink circulation channel 216 is provided in a region that communicates with the descender 214, that is, a region of the flow channel plate 232 that is in contact with the nozzle plate 230. Accordingly, since the ink circulates in the vicinity of the nozzle 202, the ink in the nozzle 202 is prevented from being thickened, and the ink can be stably jetted.

FIG. 6 is a cross-sectional view taken along line 5-5 of FIG. 4 according to a modification example. In the modification example shown in FIG. 6, the ink circulation channel 216 is provided in a region that communicates with the descender 214 and that is in contact with the vibration plate 226. Even in a case of such a configuration, the effect is lower than the effect of the ink chamber unit 206 shown in FIG. 5, but the ink can circulate in the vicinity of the nozzle 202, and the ink can be stably jetted.

### [Control of Liquid Droplet Jetting Head]

By using the liquid droplet jetting head 14 in which the ink circulates, even though the solvent of the ink is evaporated from the nozzle 202, a new ink is supplied to the ink chamber unit 206 one after another. Therefore, the jetting state can be maintained even in a vacuum environment. In particular, since water has a high vapor pressure and easily is evaporated, it is difficult to use the aqueous ink in the printing apparatus using a vacuum, but the aqueous ink can be used by the ink circulation. In addition, as will be described later, the heat generated by the liquid droplet jetting head 14 can be taken out to the outside through the ink by the ink circulation, with respect to the insufficient heat radiation of the liquid droplet jetting head 14 due to a decrease in thermal conductivity in a vacuum.

It is desirable to change an ink circulation amount between during the printing and during the non-printing of the printing apparatus 10. The term “during the printing” includes at least a state in which the liquid droplet jetting head 14 and the substrate 1 face each other. The printing apparatus 10 performs the printing by applying an ink with the liquid droplet jetting head 14 while transporting the substrate 1 via the transport device 12. In the present embodiment, a period from the substrate 1 having reached a position facing the liquid droplet jetting head 14 to the substrate 1 having passed through the position facing the liquid droplet jetting head 14 is a period during the printing, and other periods are a period during the non-printing.

Since it is desirable that a fresh ink always flows into the ink chamber unit 206 during the printing, the ink circulation amount is increased as much as possible. As for the ink circulation amount during the printing, in a case of the same ink, it is desirable to circulate the ink at the ink circulation amount of 2 times or more, more desirable to circulate the ink at the ink circulation amount of 3 times or more, and still more desirable to circulate the ink at the ink circulation amount of 5 times or more, with respect to the ink circulation amount of general ink circulation of 1000 pL/see to 10000 pL/see per nozzle.

On the other hand, since it is desired to suppress ink evaporation as much as possible during the non-printing, it is desirable to reduce the ink circulation amount during the non-printing to a level at which the nozzle 202 is not solidified by the ink evaporation, as compared to the ink circulation amount during the printing. For example, in a case of about 0.1 atmospheres, the clogging of the nozzle 202 does not occur even with the aqueous ink for a few minutes, and, in this case, stopping the ink circulation for a short time can also be selected as a method of suppressing the solvent evaporation. That is, during the non-printing, circulation stop→several minutes later→circulation→several minutes later→circulation stop . . . may be repeated. In this manner, by stopping the ink circulation at an unnecessary timing or reducing the ink circulation amount, unnecessary ink evaporation can be reduced.

In addition, in order to suppress an adverse effect on the jetting due to the evaporation of the ink solvent, it is desirable to apply vibration to a non-jetting nozzle that does not jet the ink during the printing from the piezo actuator 228 to the extent that the ink is not jetted (so-called meniscus oscillation). By combining this with the ink circulation, a fresh ink can be fed to the nozzle 202, so that an increase in the ink viscosity of the nozzle 202 can be further suppressed, and more stable jetting can be achieved.

### [Configuration of Vacuum Environment and Ink Circulation]

FIG. 7 is a schematic diagram showing a configuration example of the vacuum environment and the ink circulation of the printing apparatus 10. The printing apparatus 10 comprises a chamber 30, an exhaust mechanism 31, the upper ink tank 32, the lower ink tank 34, a return flow channel 36, and an ink pump 38.

The chamber 30 houses the transport device 12 (not shown in FIG. 7), the liquid droplet jetting head 14, the upper ink tank 32, the lower ink tank 34, the return flow channel 36, and the ink pump 38. An exhaust port (not shown) is provided in the chamber 30. The inside of the chamber 30 is pressure-reduced by the exhaust mechanism 31 such as a vacuum pump via the exhaust port. Here, the inside of the chamber 30 is maintained in a low vacuum atmosphere of 0.1 atmospheres. That is, the space S between the liquid droplet jetting head 14 and the substrate 1 is a low vacuum of 0.1 atmospheres.

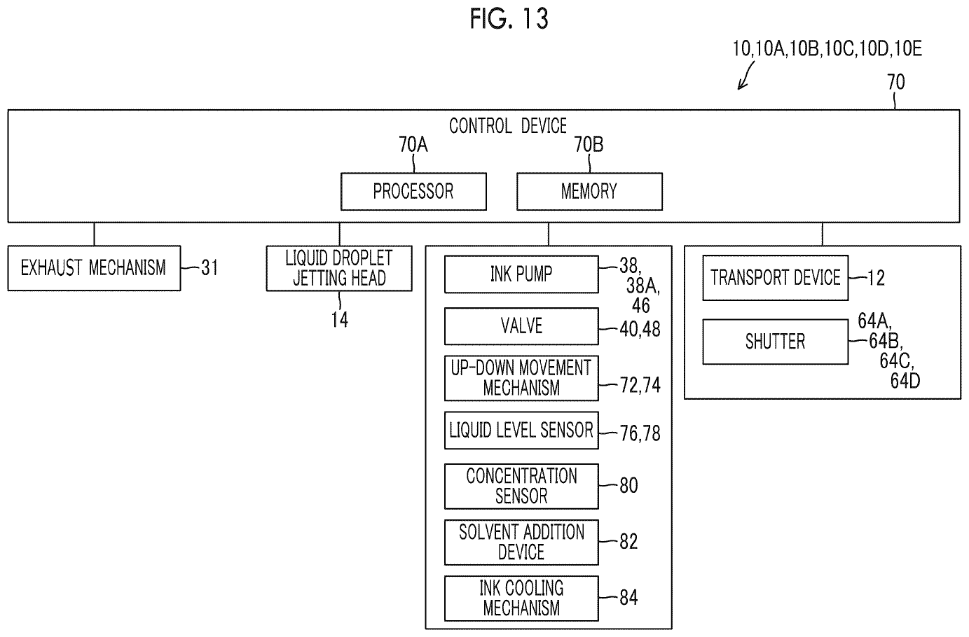

The upper ink tank 32 (an example of a “first liquid tank”) is a container for storing the ink to be supplied to the liquid droplet jetting head 14. The upper ink tank 32 communicates with the liquid droplet jetting head 14 via the ink supply channel 18. Further, the inside of the upper ink tank 32 is open to the atmosphere inside the chamber 30. The upper ink tank 32 is supported by a first up-down movement mechanism 72 (see FIG. 13) that is movable in a vertical direction (Z direction), and is disposed at a height at which a desired head difference is obtained.

The lower ink tank 34 (an example of a “second liquid tank”) is a container for storing the ink recovered from the liquid droplet jetting head 14. The lower ink tank 34 communicates with the liquid droplet jetting head 14 via the ink recovery channel 20. Further, the inside of the lower ink tank 34 is open to the atmosphere inside the chamber 30. The lower ink tank 34 is supported by a second up-down movement mechanism 74 (see FIG. 13) that is movable in the vertical direction, and is disposed at a height at which a desired head difference is obtained.

The return flow channel 36 allows the upper ink tank 32 and the lower ink tank 34 to communicate with each other. The ink pump 38, which is a liquid feed mechanism, is provided in the return flow channel 36 and feeds the ink from the lower ink tank 34 to the upper ink tank 32.

In this way, in the printing apparatus 10, the liquid droplet jetting head 14 is disposed between the upper ink tank 32 and the lower ink tank 34. The upper ink tank 32 and the lower ink tank 34 are mechanisms that cause the ink to flow by using the head difference with gravity with respect to the liquid droplet jetting head 14 based on the pressure inside the chamber 30. In this manner, a simple ink circulation configuration is obtained, and it is not necessary to prepare a mechanism that follows a pressure change in a low vacuum region, and thus the control is facilitated.

It goes without saying that, as described in JP2017-65159A, the ink may be circulated by pressure control with a pump based on the atmospheric pressure. However, the method shown in FIG. 7 is simple and is easily controlled.

The ink circulation amount can be controlled by the first up-down movement mechanism 72 and the second up-down movement mechanism 74. In order to minimize the effect on the jetting, it is desirable that the up-down movement of the upper ink tank 32 and the lower ink tank 34 is performed at a timing at which the ink is not jetted from the liquid droplet jetting head 14.

### Ink Pump Disposition: Second Embodiment

The ink pump 38 is preferably not provided in the low vacuum region. Although there is a pump that can handle the low vacuum region, the cost is high, and there is also a concern that grease of the ink pump 38 may be evaporated. Therefore, the ink pump 38 is installed outside the low vacuum region.

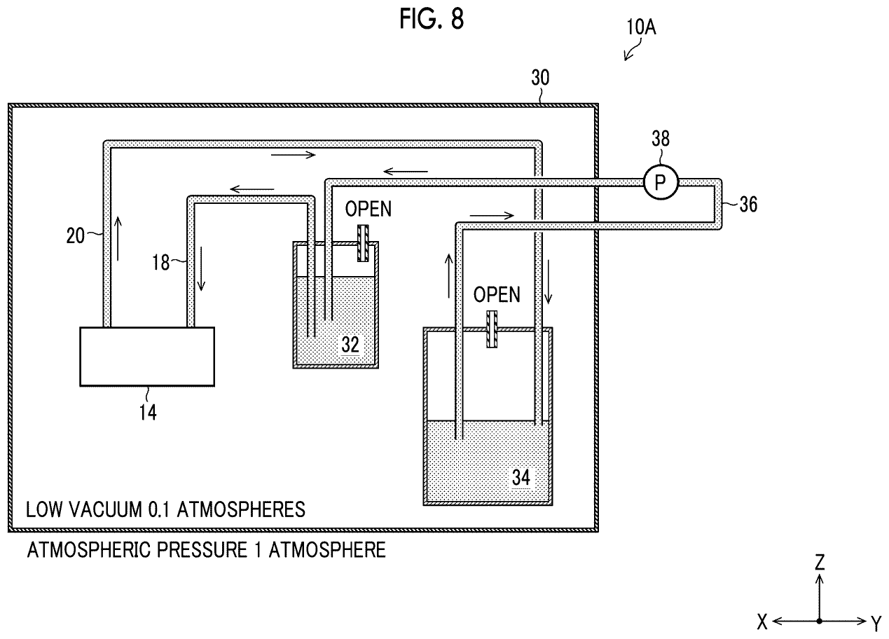

FIG. 8 is a schematic diagram showing a configuration example of a printing apparatus 10A according to the second embodiment. In the example shown in FIG. 8, the ink pump 38 is disposed outside the chamber 30.

As described above, by providing the ink pump 38 in the atmospheric pressure region, the ink pump 38 can be operated in an environment in which the ink pump 38 is easily operated. In a case in which it is confirmed that the ink stored in the upper ink tank 32 is reduced from a detection result of a first liquid level sensor 76 (see FIG. 13) provided in the upper ink tank 32, and the ink stored in the lower ink tank 34 is sufficient from a detection result of a second liquid level sensor 78 (see FIG. 13) provided in the lower ink tank 34, the ink pump 38 can be operated to pump the ink from the lower ink tank 34 to the upper ink tank 32.

It should be noted that a tube of the return flow channel 36 disposed in the atmospheric pressure region needs to be a hard tube or a pipe so as not to be crushed by an external pressure in a case in which the ink in the negative pressure state flows.

Similarly, since the pressure change also occurs in the tube of the return flow channel 36 disposed in the low vacuum region, it is desirable that the tube is a hard tube. On the other hand, a cable carrier (registered trademark) (not shown) is used for the tube of the return flow channel 36 for tube handling associated with the operation of the liquid droplet jetting head 14. Therefore, it is desirable that the tube of the return flow channel 36 is hard enough to withstand the movement of the cable carrier (registered trademark). For example, it is preferable to use NOVATEC (registered trademark) LD-LA320 manufactured by Japan Polyethylene Corporation.

### Ink Replenishment: Third Embodiment

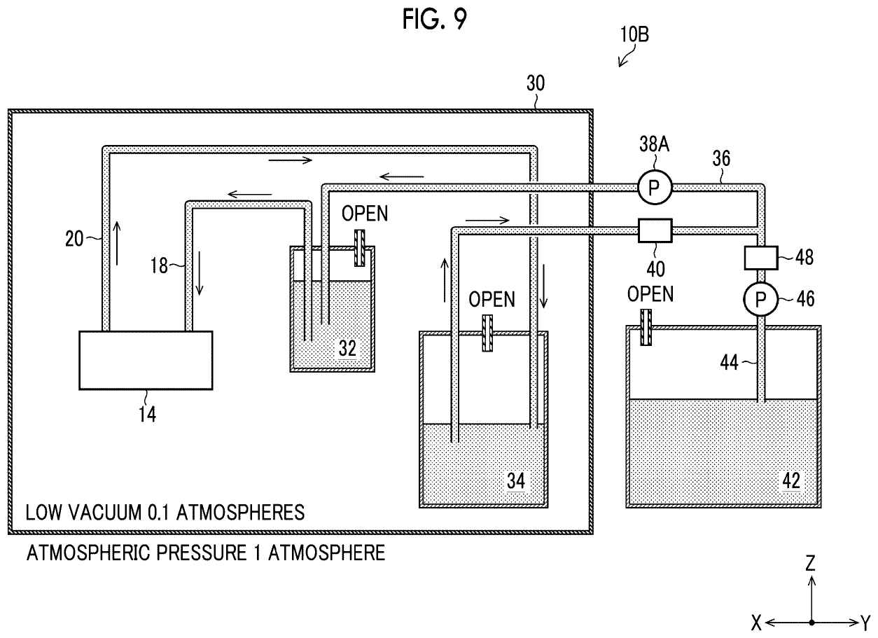

Further, it is desirable that ink replenishment is also performed from the outside of the low vacuum region. FIG. 9 is a schematic diagram showing a configuration example of a printing apparatus 10B according to the third embodiment.

The printing apparatus 10B comprises a first ink pump 38A, a first valve 40, a ink tank for replenishment 42, a replenishment flow channel 44, a second ink pump 46, and a second valve 48.

The first ink pump 38A is disposed outside the chamber 30. The first valve 40 is provided in the return flow channel 36 outside the chamber 30. The first valve 40 switches between passing and blocking of the ink in the return flow channel 36 under control of a control device 70 (see FIG. 13).

The ink tank for replenishment 42 is provided outside the chamber 30. The ink tank for replenishment 42 is a container for storing the ink for replenishing the lower ink tank 34. The ink tank for replenishment 42 communicates with the return flow channel 36 via the replenishment flow channel 44. In addition, the inside of the ink tank for replenishment 42 is open to the atmosphere of the atmospheric pressure outside the chamber 30.

The second ink pump 46 and the second valve 48 are provided in the replenishment flow channel 44. The second ink pump 46 feeds the ink from the ink tank for replenishment 42 to the upper ink tank 32. The second valve 48 switches between passing and blocking of the ink in the replenishment flow channel 44 under the control of the control device 70 (see FIG. 13).

In a case in which the inks in the upper ink tank 32 and the lower ink tank 34 are insufficient, the printing apparatus 10B configured as described above performs the printing until a proper break, and then opens the inside of the chamber 30 to the atmosphere. Then, by opening the second valve 48 and driving the first ink pump 38A and the second ink pump 46, the ink stored in the ink tank for replenishment 42 can be fed to the upper ink tank 32. In a case in which the ink is fed to the lower ink tank 34, the ink stored in the ink tank for replenishment 42 can be fed to the lower ink tank 34 by opening the first valve 40 and the second valve 48 and driving the second ink pump 46.

Although not desirable, in a case in which it is desired to replenish the upper ink tank 32 with the ink stored in the ink tank for replenishment 42 during the printing, the first ink pump 38A and the second ink pump 46 need only be gently driven after the second valve 48 is opened.

In addition, since the solvent is evaporated quickly in the low vacuum region, the solvent in the ink is gradually reduced even though the ink is circulated. Therefore, the ink is extracted from an ink extraction place (not shown) in the atmospheric pressure region, and the components of the ink are evaluated by a concentration sensor 80 (see FIG. 13, an example of a “concentration measurement device”), so that it is possible to determine whether or not the ink is in an appropriate state. In addition, the concentration can be adjusted to an appropriate concentration by adding a lacking solvent to the ink in a solvent addition device 82 (see FIG. 13).

It should be noted that, in a case in which it is revealed that the solvent in the ink is largely reduced, the thickened ink may be extracted and disposed of from an ink tube (not shown), and a new ink may be supplied from the ink tank for replenishment 42.

### Solvent Evaporation Prevention: Fourth Embodiment

In order to prevent the ink solvent from being evaporated from the liquid levels of the upper ink tank 32 and the lower ink tank 34, a surface area exposed by floating a film or beads on the liquid level may be reduced.

Further, the upper ink tank 32 and the lower ink tank 34 may be closed with a soft material such as a damper membrane that can follow a change in external pressure, instead of being opened to the atmosphere inside the chamber 30. The upper ink tank 32 and the lower ink tank 34 may be configured to deform as a whole like a pouch.

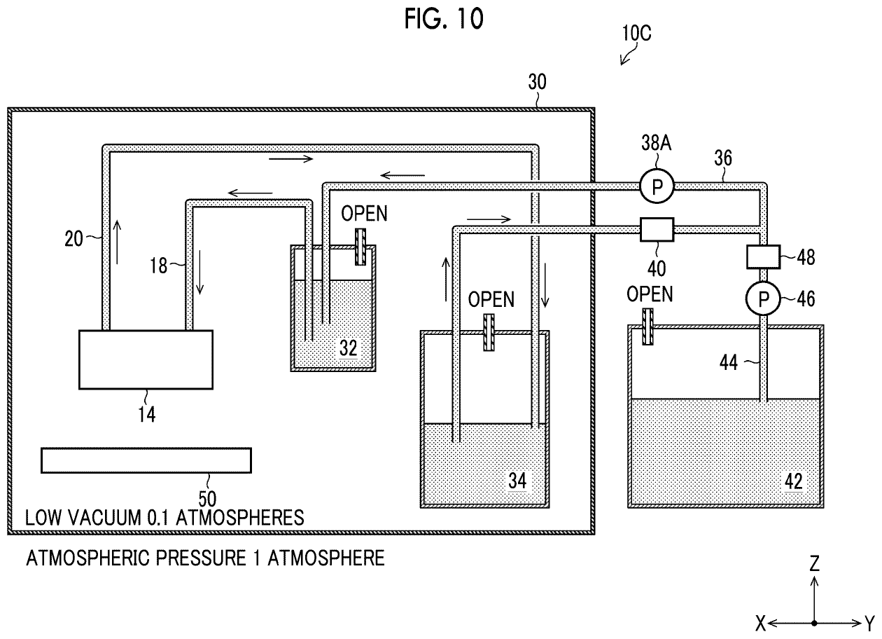

Further, in order to prevent the solvent from being evaporated from the nozzle 202 of the liquid droplet jetting head 14, only the solvent may be added in advance into the chamber 30. FIG. 10 is a schematic diagram showing a configuration example of a printing apparatus 10C according to the fourth embodiment. The printing apparatus 10C comprises a container 50 inside the chamber 30. The container 50 is disposed at a position below the liquid droplet jetting head 14 in the vertical direction. The container 50 contains the solvent (here, water) of the ink inside, and the solvent is in an open state with respect to an internal space of the chamber 30. Therefore, the solvent inside the container 50 is naturally evaporated. As a result, a degree of vacuum inside the chamber 30 is slightly lowered, but a partial pressure of the solvent can be increased, and the ink can be prevented from being evaporated from the nozzle 202.

### Heat Generation of Liquid Droplet Jetting Head: Fifth Embodiment

In a case in which the liquid droplet jetting head is handled in the low vacuum region, there is a concern that the liquid droplet jetting head itself generates heat. In a case of an ink jet head using a piezo actuator, the piezo actuator itself generates heat, and an application-specific integrated circuit (ASIC) that outputs a drive voltage for controlling the piezo actuator also generates heat. It goes without saying that the substrate itself that supplies electric power to the ink jet head and transmits a signal also generates heat.

It is of course desirable that the substrate is disposed outside the low vacuum region. In addition, it is desirable that the ASIC is not mounted in the ink jet head itself, but is disposed at a position away from the ink jet head and is located outside the low vacuum region.

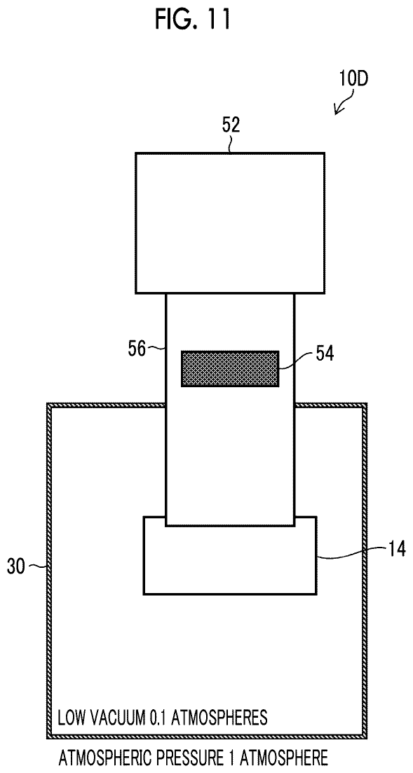

FIG. 11 is a schematic diagram showing a configuration example of a printing apparatus 10D according to the fifth embodiment. The printing apparatus 10D comprises a control substrate 52, an ASIC 54, and a flexible cable 56.

The control substrate 52 transmits a control signal for controlling the liquid droplet jetting head 14 to the ASIC 54. The ASIC 54 (an example of a “circuit element”) distributes the signal received from the control substrate 52 to the plurality of piezo actuators 228 and outputs the drive voltage. The flexible cable 56 is a wiring line that transmits the signal and the drive voltage between the control substrate 52, the ASIC 54, and the liquid droplet jetting head 14.

The control substrate 52 is disposed at an end portion of the flexible cable 56, and the ASIC 54 is disposed at a position between both ends of the flexible cable 56. The control substrate 52 and the ASIC 54 are disposed outside the chamber 30. As described above, by disposing a heat source outside the chamber 30, heat can be radiated outside the chamber 30, and an increase in temperature of the low vacuum region inside the chamber 30 can be prevented.

It goes without saying that the ink circulation also has an effect of the heat radiation from the liquid droplet jetting head 14. The effect of the ink circulation is present for both a situation in which the ink is likely to evaporate and a situation in which the thermal conductivity is deteriorated, which occur in the low vacuum region.

It should be noted that, in order to suppress the evaporation of the ink as much as possible, it is desirable that the ink is used after being cooled. The ink can be cooled by applying an ink cooling mechanism 84 (see FIG. 13) to the ink supply channel 18, the ink recovery channel 20, the upper ink tank 32, the lower ink tank 34, and the like. A chiller, a Peltier element, or the like through which a coolant flows can be used as the ink cooling mechanism 84. The ink cooling mechanism 84 cools the ink to, for example, 20° C. In a case in which the viscosity of the cooled ink is increased, a voltage waveform applied to the piezo actuator 228 of the liquid droplet jetting head 14 need only be increased.

### Carrying-In and Carrying-Out of Substrate: Sixth Embodiment

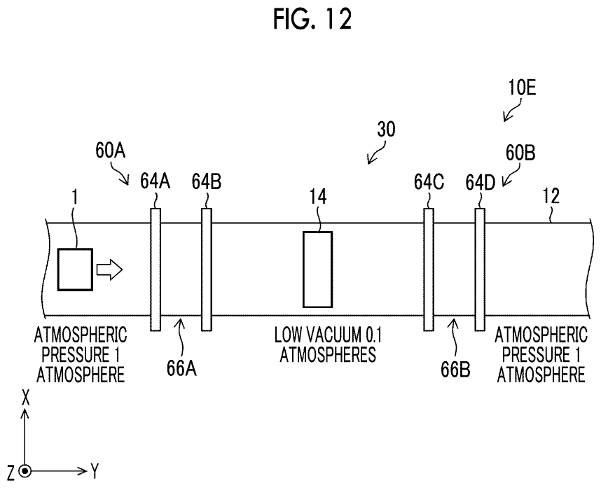

FIG. 12 is a schematic diagram showing a configuration example of a printing apparatus 10E according to the sixth embodiment. The chamber 30 of the printing apparatus 10E comprises a carry-in slit 60A, a carry-out slit 60B, and a first shutter 64A, a second shutter 64B, a third shutter 64C, and a fourth shutter 64D that are each openable and closable.

The carry-in slit 60A is a slit-shaped opening portion for carrying in the substrate 1 from the outside of the chamber 30 to the inside. The carry-out slit 60B is a slit-shaped opening portion for carrying out the substrate 1 from the inside of the chamber 30 to the outside.

The first shutter 64A, the second shutter 64B, the third shutter 64C, and the fourth shutter 64D are disposed on a transport channel of the substrate 1 by the transport device 12. The first shutter 64A is disposed in the carry-in slit 60A to open and close the carry-in slit 60A. The fourth shutter 64D is disposed at the carry-out slit 60B to open and close the carry-out slit 60B.

The chamber 30 includes a first pressure adjustment chamber 66A that is a space relatively narrower than the low vacuum region in which the liquid droplet jetting head 14 and the like inside the chamber 30 are disposed, between the first shutter 64A and the second shutter 64B. In addition, the chamber 30 includes a second pressure adjustment chamber 66B that is a space relatively narrow with respect to the low vacuum region inside the chamber 30, between the third shutter 64C and the fourth shutter 64D. The first pressure adjustment chamber 66A and the second pressure adjustment chamber 66B each comprise a vacuum pump (not shown).

The second shutter 64B switches between opening and blocking between the first pressure adjustment chamber 66A and the low vacuum region. The third shutter 64C switches between opening and blocking between the low vacuum region and the second pressure adjustment chamber 66B.

In a case in which the substrate 1 outside the chamber 30 is transported into the chamber 30, first, the first shutter 64A is opened, the substrate 1 is carried in the first pressure adjustment chamber 66A by the transport device 12, and the first shutter 64A is closed. Next, the first pressure adjustment chamber 66A is brought into a low vacuum state (for example, 0.1 atmospheres) by the vacuum pump, the second shutter 64B is opened, the substrate 1 is carried in the low vacuum region of the chamber 30 by the transport device 12, and the second shutter 64B is closed.

In addition, in a case in which the substrate 1 inside the chamber 30 is transported to the outside of the chamber 30, first, the first pressure adjustment chamber 66A is brought into the low vacuum state by the vacuum pump. Then, the third shutter 64C is opened, the substrate 1 is carried in the second pressure adjustment chamber 66B by the transport device 12, and the third shutter 64C is closed. Next, the fourth shutter 64D is opened, the substrate 1 is carried out of the chamber 30 by the transport device 12, and the fourth shutter 64D is closed. Then, the second pressure adjustment chamber 66B is brought into the low vacuum state.

By transporting the substrate 1 as described above, the substrate 1 can be carried in the low vacuum region without introducing a large amount of air into the low vacuum region in which the liquid droplet jetting head 14 is located.

### <Electric Configuration>

FIG. 13 is a block diagram showing an electric configuration of the printing apparatuses 10, 10A, 10B, 10C, 10D, and 10E. The printing apparatuses 10, 10A, 10B, 10C, 10D, and 10E comprise the control device 70. The control device 70 includes a processor 70A and a memory 70B.

The processor 70A executes a command stored in the memory 70B. A hardware structure of the processor 70A is various processors as follows. Various processors include a central processing unit (CPU) as a general-purpose processor that operates as various function units by executing software (program), a graphics processing unit (GPU) as a processor specialized in image processing, a programmable logic device (PLD) as a processor of which a circuit configuration can be changed after manufacture, such as a field programmable gate array (FPGA), a dedicated electric circuit as a processor of which a circuit configuration is specifically designed to execute specific processing, such as an application-specific integrated circuit (ASIC), and the like.

One processing unit may be configured by one of these various processors, or may be configured by two or more processors of the same type or different types (for example, a plurality of FPGAs, or a combination of a CPU and an FPGA, or a combination of a CPU and a GPU). Further, a plurality of function units may be configured by one processor. As a first example in which the plurality of function units are configured by one processor, as represented by a computer such as a client or a server, there is a form in which one processor is configured by a combination of one or more CPUs and software, and this processor operates as the plurality of function units. As a second example thereof, as represented by a system-on-a-chip (SoC), there is a form in which a processor, which implements the functions of the entire system including the plurality of function units by one integrated circuit (IC) chip, is used. As described above, various function units are configured by one or more of the various processors as the hardware structure.

Further, the hardware structure of the various processors is, more specifically, an electric circuit (circuitry) in which circuit elements such as semiconductor elements are combined.

The memory 70B stores the command executed by the processor 70A. The memory 70B includes a random-access memory (RAM) and a read-only memory (ROM). The processor 70A uses the RAM as a work area, executes software using various programs and parameters stored in the ROM, and uses the parameters stored in the ROM or the like to execute various types of processing for controlling the printing apparatuses 10, 10A, 10B, 10C, 10D, and 10E.

The control device 70 controls the exhaust mechanism 31. That is, the control device 70 reduces the pressure inside the chamber 30 via the exhaust mechanism 31 and maintains the inside of the chamber 30 in, for example, the low vacuum atmosphere of 0.1 atmospheres. In addition, the control device 70 reduces the pressure inside the first pressure adjustment chamber 66A and the second pressure adjustment chamber 66B via the vacuum pump (not shown) during the carrying-in and carrying-out of the substrate 1, and sets the inside of the first pressure adjustment chamber 66A and the second pressure adjustment chamber 66B to the low vacuum state.

The control device 70 controls the liquid droplet jetting head 14. That is, the control device 70 causes the nozzle 202 of the liquid droplet jetting head 14 to jet the liquid droplets I of the ink, to form an image on the substrate 1. In addition, the control device 70 applies vibration to the piezo actuator 228 of the non-jetting nozzle 202 to vibrate the meniscus of the non-jetting nozzle 202 to such an extent that the ink is not jetted during the printing.

The control device 70 controls the transport device 12, the first shutter 64A, the second shutter 64B, the third shutter 64C, and the fourth shutter 64D. That is, the control device 70 transports the substrate 1 in the Y direction via the transport device 12. In addition, in a case in which the substrate 1 is carried in the chamber 30, the control device 70 opens and closes the first shutter 64A and the second shutter 64B in order, and prevents a large amount of air from entering the low vacuum region inside the chamber 30. Further, in a case in which the substrate 1 is carried out of the chamber 30, the control device 70 opens and closes the third shutter 64C and the fourth shutter 64D in order, and prevents a large amount of air from entering the low vacuum region inside the chamber 30.

The control device 70 controls the ink pump 38. That is, the control device 70 pumps the ink from the lower ink tank 34 to the upper ink tank 32 via the ink pump 38.

The control device 70 controls the first ink pump 38A, the second ink pump 46, the first valve 40, and the second valve 48. That is, the control device 70 opens the first valve 40, drives the first ink pump 38A, and feeds the ink from the lower ink tank 34 to the upper ink tank 32. In addition, the control device 70 opens the second valve 48, drives the first ink pump 38A and the second ink pump 46, and feeds the ink from the ink tank for replenishment 42 to the upper ink tank 32. Further, the control device 70 opens the first valve 40 and the second valve 48, drives the second ink pump 46, and feeds the ink from the ink tank for replenishment 42 to the lower ink tank 34.

The control device 70 controls the first up-down movement mechanism 72 and the second up-down movement mechanism 74. That is, the control device 70 controls the circulation of the ink of the liquid droplet jetting head 14 by adjusting the position of the upper ink tank 32 in the vertical direction via the first up-down movement mechanism 72, adjusting the head difference between the upper ink tank 32 and the liquid droplet jetting head 14, adjusting the position of the lower ink tank 34 in the vertical direction via the second up-down movement mechanism 74, and adjusting the head difference between the liquid droplet jetting head 14 and the lower ink tank 34.

The control device 70 sets the circulation amount of the ink during the printing by the liquid droplet jetting head 14 to be greater than the circulation amount of the ink during the non-printing. The control device 70 stops the circulation of the ink during the non-printing.

The control device 70 acquires the detection results from the first liquid level sensor 76 and the second liquid level sensor 78. That is, the control device 70 checks an amount of the ink stored in the upper ink tank 32 from the detection result of the first liquid level sensor 76. In addition, the control device 70 checks an amount of ink stored in the lower ink tank 34 from the detection result of the second liquid level sensor 78.

The control device 70 acquires the detection result from the concentration sensor 80. That is, the control device 70 checks a solvent amount of the ink from the detection result of the concentration sensor 80.

The control device 70 controls the solvent addition device 82. That is, the control device 70 adds, to the ink, an amount of the solvent corresponding to the detection result of the concentration sensor 80 to adjust the concentration of the solvent of the ink.

The control device 70 controls the ink cooling mechanism 84. That is, the control device 70 cools the ink to a desired temperature via the ink cooling mechanism 84.

With the printing apparatuses 10, 10A, 10B, 10C, 10D, and 10E configured as described above, it is possible to perform a manufacturing method of a printed article, the manufacturing method including setting the space S between the liquid droplet jetting head 14 and the substrate 1 to a low vacuum, circulating the ink in the liquid droplet jetting head 14, and moving the substrate 1 and the liquid droplet jetting head 14 relative to each other via the transport device 12 and causing the liquid droplet jetting head 14 to jet the ink, to perform the printing on the substrate 1.

With the printing apparatuses 10, 10A, 10B, 10C, 10D, and 10E, since the space S between the liquid droplet jetting head 14 and the substrate 1 is the low vacuum, the air resistance against the liquid droplets I can be reduced. In addition, by circulating the ink in the liquid droplet jetting head 14, the jetting state can be stabilized even in a case in which the solvent is evaporated from the ink.

### Others

Here, although the printing apparatus that applies the conductive ink to the print substrate has been described as the liquid droplet jetting apparatus, the substrate and the ink are not limited thereto. The liquid droplet jetting apparatus can be applied to a substrate having unevenness on a surface of paper, fabric, leather, metal, resin, glass, wood, and the like. The substrate is not limited to the substrate that is entirely housed in the chamber, and may have a long shape that extends inside and outside the chamber.

The liquid droplet jetting apparatus can apply the ink such as a color ink containing a coloring material, an ultraviolet curable ink that is cured by ultraviolet irradiation, or an insulating ink having insulating properties. The liquid droplet jetting apparatus can use a number of liquid droplet jetting heads in accordance with the type of ink, and a plurality of liquid droplet jetting heads may be disposed in one chamber, or a chamber may be provided for each liquid droplet jetting head.

The technical scope of the present invention is not limited to the scope described in the embodiments described above. The configurations and the like in the respective embodiments can be appropriately combined between the respective embodiments without departing from the gist of the present invention.

### EXPLANATION OF REFERENCES

1: substrate
10: printing apparatus
10A: printing apparatus
10B: printing apparatus
10C: printing apparatus
10D: printing apparatus
10E: printing apparatus
12: transport device
14: liquid droplet jetting head
16: L-shaped bracket
18: ink supply channel
18A: ink supply port
20: ink recovery channel
20A: ink discharge port
22: filter housing
24: silicon die
30: chamber
31: exhaust mechanism
32: upper ink tank
34: lower ink tank
36: return flow channel
38: ink pump
38A: first ink pump
40: first valve
42: ink tank for replenishment
44: replenishment flow channel
46: second ink pump
48: second valve
50: container
52: control substrate
54: ASIC
56: flexible cable
60A: carry-in slit
60B: carry-out slit
64A: first shutter
64B: second shutter
64C: third shutter
64D: fourth shutter
66A: first pressure adjustment chamber
66B: second pressure adjustment chamber
70: control device
70A: processor
70B: memory
72: first up-down movement mechanism
74: second up-down movement mechanism
76: first liquid level sensor
78: second liquid level sensor
80: concentration sensor
82: solvent addition device
84: ink cooling mechanism
200: nozzle surface
202: nozzle
204: pressure chamber
206: ink chamber unit
210: supply tributary
212: common flow channel
214: descender
216: ink circulation channel
218: recovery tributary
220: circulation common flow channel
222: jetting element
226: vibration plate
228: piezo actuator
230: nozzle plate
232: flow channel plate
I: liquid droplet
S: space

What is claimed is:

1. A liquid droplet jetting apparatus comprising:
a liquid droplet jetting head that jets a liquid;
a relative movement mechanism that moves a substrate and the liquid droplet jetting head relative to each other; and
a control device that moves the substrate and the liquid droplet jetting head relative to each other and causes the liquid droplet jetting head to jet the liquid, to print an image on the substrate,
wherein a space between the liquid droplet jetting head and the substrate is a vacuum,
the liquid droplet jetting head includes a circulation flow channel inside the liquid droplet jetting head, and
the control device circulates the liquid through the circulation flow channel at least during printing.

2. The liquid droplet jetting apparatus according to claim 1,
wherein the liquid droplet jetting head includes a jetting element including a nozzle, a pressure chamber, and a jetting energy generation element, and
the circulation flow channel includes a supply flow channel for supplying the liquid to the jetting element and a recovery flow channel for recovering the liquid from the jetting element.

3. The liquid droplet jetting apparatus according to claim 1, further comprising:
a first liquid tank and a second liquid tank that store the liquid,
wherein the control device supplies the liquid from the first liquid tank to the liquid droplet jetting head by using a head difference, and recovers the liquid from the liquid droplet jetting head to the second liquid tank by using the head difference.

4. The liquid droplet jetting apparatus according to claim 3, further comprising:
a chamber that internally houses the liquid droplet jetting head, the relative movement mechanism, the first liquid tank, and the second liquid tank; and
an exhaust mechanism that creates a vacuum inside the chamber,
wherein a reference of the head difference is a pressure inside the chamber.

5. The liquid droplet jetting apparatus according to claim 4, further comprising:
a liquid feed mechanism that supplies the liquid from the second liquid tank to the first liquid tank,
wherein the liquid feed mechanism is disposed outside the chamber.

6. The liquid droplet jetting apparatus according to claim 1,
wherein the control device sets a circulation amount of the liquid during the printing to be greater than a circulation amount of the liquid during non-printing.

7. The liquid droplet jetting apparatus according to claim 1,
wherein the control device stops the circulation of the liquid during non-printing.

8. The liquid droplet jetting apparatus according to claim 1,
wherein the control device applies vibration to a non-jetting nozzle during the printing to an extent that the liquid droplet is not jetted.

9. The liquid droplet jetting apparatus according to claim 1,
wherein the liquid contains a solvent,
the liquid droplet jetting apparatus further comprises a concentration measurement device that measures a concentration of the circulated liquid, and
the control device adds an amount of the solvent that compensates for evaporation of the solvent to the liquid.

10. The liquid droplet jetting apparatus according to claim 1, further comprising:
a chamber that internally houses the liquid droplet jetting head and the relative movement mechanism; and
an exhaust mechanism that creates a vacuum inside the chamber,
wherein the liquid contains a solvent, and
the solvent is disposed inside the chamber in an open state.

11. The liquid droplet jetting apparatus according to claim 1, further comprising:
a chamber that internally houses the liquid droplet jetting head and the relative movement mechanism;
an exhaust mechanism that creates a vacuum inside the chamber; and
a circuit element for driving the liquid droplet jetting head,
wherein the circuit element is disposed outside the chamber.

12. The liquid droplet jetting apparatus according to claim 1,
wherein the vacuum is 0.5 atmospheres to 0.01 atmospheres.

13. The liquid droplet jetting apparatus according to claim 1, further comprising:
a cooling mechanism that cools the liquid.

14. The liquid droplet jetting apparatus according to claim 1,
wherein the liquid is an aqueous ink containing water as a solvent.

15. A manufacturing method of a printed article, the manufacturing method comprising:
creating a vacuum between a liquid droplet jetting head and a substrate, moving the substrate and the liquid droplet jetting head relative to each other, and causing the liquid droplet jetting head to jet a liquid, to print an image on the substrate; and
circulating the liquid through a circulation flow channel of the liquid droplet jetting head at least during printing.
